(19) United States
(12) Patent Application Publication
(10) Pub. No.: US 2006/0102105 A1
(43) Pub. Date: May 18, 2006

(54) Control or guide means for animals

(76) Inventors: Mark Sohler, Wangen (DE); Hubert Schneider, Wangen (DE)

Correspondence Address: ROBERT W. BECKER & ASSOCIATES, 707 HIGHWAY 66 EAST, SUITE B, TIJERAS, NM, 87059, US

(21) Appl. No.: 11/255,095

(22) Filed: Oct. 20, 2005

(30) Foreign Application Priority Data
Oct. 20, 2004 (DE) 10 2004 051 151.9

(51) Int. Cl. A01K 27/00

(52) U.S. Cl. 119/858

(57) ABSTRACT

A control or guide device for an animal comprising a collar or harness that releasably extends about the neck of the animal, a device for fixing a prescribed position of rotation of the collar relative to the animal, and a connecting mechanism disposed on the collar and provided with a connection stub that extends upwardly when the collar is on the animal. The connection stub is connected to the collar such that it cannot kink. On an end remote from the collar, the connection stub is provided with a coupling, such as a ring or a snap-in device, for receiving a flexible and slack connecting element such as a leash or chain.

The invention concerns a control or guide means for animals, according to the introductory portion of claim 1.

Control or guide means for animals, intended for a safe guiding of the animal in question, e.g. a dog, even if e.g. the dog pulls the guide means, have been known for some time. A stress situation that is particularly critical is lateral pulling. If the person guiding the animal is running or even riding a bike, lateral pulling often causes the person to fall down.

In the situation described above, the lateral force applied by the pet can hardly be controlled, so that it can easily cause the person guiding the animal to fall down.

To reduce the force, different features have become known. It has for example become known to equip the flexible or slack connecting component, in other words the leash for restraining the animal, with a spring element. By means of the spring element, the applied force is evened out somewhat, so that it does not build up as jerkily.

Furthermore, flexible leashes for dogs, with the leash rolled up on a reel, have become known. In order to release the leash and allow the dog to move, the person guiding the dog is supposed to press a release button, so that the dog can initially move in any direction. However, this can also lead to unfavorable situations, for example if the dog and the person guiding it are moving towards two different sides of a tree, so that the extended leash is caught by the tree.

So-called choke collars have become known to keep a pet, especially a dog, from applying significant pulling force, especially in a lateral direction. Such collars choke the neck of the dog as soon as it pulls the leash. Choke collars can be provided with spikes pointing inwardly, or in other words, pointing towards the neck of the dog.

Those fond of animals, however, reject such solutions.

Another problem has to do with the fact that the leash or chain is flexible or slack. The problem appears particularly when the pet is on the leash and both person and animal are moving rapidly. The leash typically droops rather than being held completely under tension, especially if the dog or e.g. the cat follows the person guiding it willingly. In that condition, the leash can form a loop, reaching to the ground, resulting in the significant danger that the dog or other pet may step on the leash, or may step over it. If a bigger dog accidentally steps on the leash with its paw, that provokes a sudden stop which may cause the person guiding the dog to fall down, e.g. if that person is jogging or riding a bike.

Even if the dog simply steps over the leash with one of its front paws, the leash then runs awkwardly behind the pertaining front paw so that the dog is hindered in its movement. The person guiding the animal then has to stop and see to it that the leash extends in the right way again.

A neck and chest collar or harness for dogs and other animals that permits different locking positions is known from DE 38 37 507 A1. In one of the locking positions, it is intended that a metal ring, which is supposed to serve as a coupling for the leash, stay by the neck of the dog. In this solution, however, the leash can also droop to the side of the dog's body and can therefore cause the dog to trip.

It is therefore an object of the invention to develop a control or guide means for animals according to the introductory portion of claim 1, which is ergonomically improved, especially for jogging or riding a bike together with the animal, yet does not cause significant additional costs.

This object is realized by the invention described in claim 1. Advantageous embodiments are described in the dependent claims. The control or guide means according to the invention enables for the flexible and slack connecting element (in other words the leash or chain) to be sustained in an upright manner, i.e. off the ground. It therefore ensures that the connecting element not get into the area of the dog's or other animal's legs, even if the dog or the other animal runs fairly close to the person guiding it. Therefore, a connection stub is provided according to the invention. The connection stub is fastened to the animal in such a way that it cannot kink. The connection stub directs the leash or chain upwardly and away from the animal. The leash is flexible and slack, yet it typically has a certain bending radius that can be used in an advantageous embodiment of the invention. It can ensure that the leash extends away from the back or neck of the pet, primarily forming a long arc, and then extending sideways towards the person guiding the animal without touching the ground.

In an advantageous embodiment, the bending radius measures at least 10 cm, which can be easily accomplished with a stiff leash, such as a leash made of leather. According to the invention, a leash is therefore preferred rather than a chain.

Even though the leash is conducted upwardly, the dog or other animal can be held securely.

The leash according to the invention is particularly suitable for training a dog, starting even at the age of a puppy. The leash extends upwardly rather than hanging down from the neck and bothering the dog while sniffing or digging. Hence, it can be avoided that the dog develops an aversion against being on a leash.

The specific configuration can naturally be adapted to the requirements over a wide range. By means of the coupling it can for example be ensured that the part of the leash that is adjacent to the connection stub initially extends in the same direction as the connection stub before it runs downwardly. It is furthermore possible to adapt, over a wide range, the height of the connection stub to the requirements. A short connection stub is sufficient if a snap-in device is used for coupling. A long connection stub, however, is adequate if a ring or eyelet is used for coupling, to which e.g. a carabiner or spring clip on the leash can be latched.

In one preferred embodiment, it is intended for the connection stub to be sufficiently stiff in order to support a fairly heavy leash or chain in an upright manner. Nevertheless, the connection stub is elastic and can be bent, preferably to the sides. Hence, if the pet suddenly moves sideways, a certain spring effect is additionally granted by the invention.

Further advantages, details and characteristics derive from the following description of the invention with the aid of the drawings, in which:

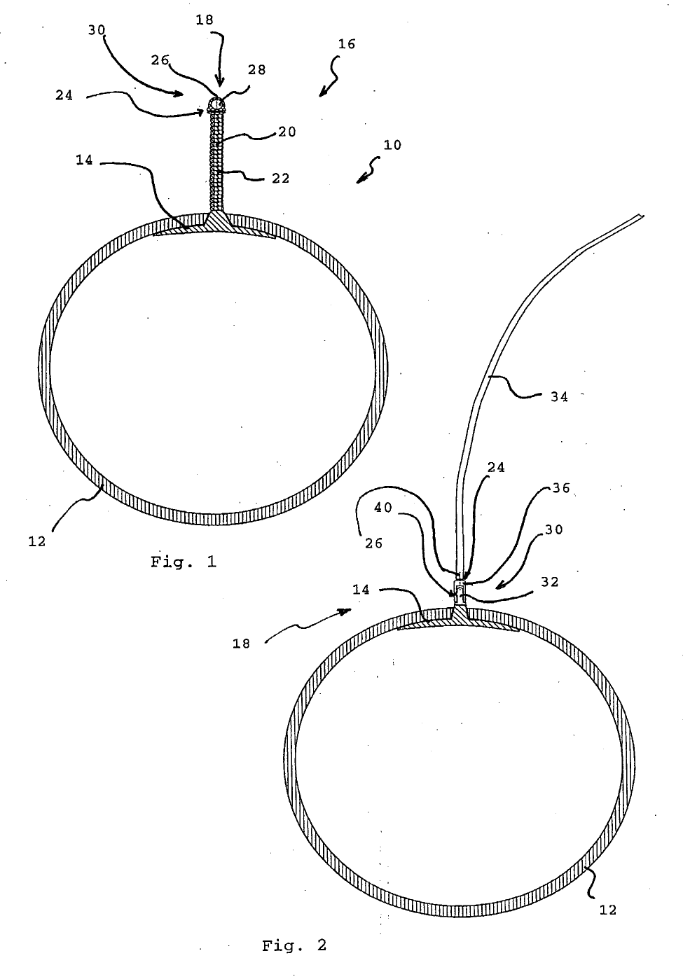

FIG. 1 shows a schematic view of a first embodiment of a control or guide means according to the invention; and

FIG. 2 shows a schematic view of a second embodiment of a control or guide means according to the invention.

In FIG. 1, a part of a control or guide means 10, according to the invention, is represented schematically. The control or guide means according to the invention comprises a collar 12, which is represented schematically in FIG. 1. For simplicity's sake, the collar 12 is shown in a closed condition. Certainly, a typical collar instead comprises a locking or closing device, which is not shown in the drawing.

Furthermore, the collar 12 is provided with a device for fixing the position, which is not represented in the drawing either. The device can e.g. be formed of an additional strap which extends between the front legs of the animal and is directed back to the collar 12. Hence, despite movement of the pet, it is ensured that the position of the collar 12 does not shift.

According to the invention, a support area 14 of the collar is located at the top, approximately by the neck of the animal. In one advantageous embodiment, a widened neck support is provided there. The neck support can e.g. be formed of a somewhat wider leather strap, which is connected to the collar there.

According to the invention, a connecting means 16 for connecting the leash that serves to control and guide the animal is provided. For this purpose, the embodiment represented comprises a connection stub 18, which is fixedly attached to the support area 14. In the embodiment represented here, the support area 14 is placed underneath the collar 12. Of course, it is possible to place the support area 14 on top of the collar 12 instead. According to another alternative embodiment, the connection stub 18 is directly attached to the collar 12.

In the embodiment represented here, the connection stub 18 comprises a pretensioned spring 20, made e.g. of spring steel. The individual spirals 22 of the spring 20 rest, pretensioned, on top of each other. Therefore, the spring 20 tends to stay upright and can be elastically bent to the side only after applying an initial bending force.

The spring 20 terminates in a swivel joint 24, which can be swiveled freely around a vertical axis 26.

The swivel joint 24 connects the spring 20 to an eyelet 28. In the embodiment described here, the eyelet 28 has a circular opening and serves as a coupling 30, through which the person guiding the animal can releasably connect a leash, using e.g. a carabiner.

In the embodiment described here, the spring 20 contains an internal tie rod, which prevents the spring from being expanded beyond its elastic range and hence made unusable. Nevertheless, the tie rod permits free movement of the spring 20, as long as the elastic range is not exceeded.

According to the invention and according to the embodiment described here it is intended for the connection stub 18 to always extend upwardly. Therefore, the coupling point for the leash is significantly moved upwardly, e.g. by 10 or even 20 cm. The risk of the pet stepping into a loop formed by the leash with its paws is clearly less or is even eliminated, even if the leash is drooping. Nevertheless, the animal can move freely, and even if it rolls on its back, the connection stub 18, which is elastically bendable, is not damaged.

A modified embodiment of the control or guide means according to the invention is represented in FIG. 2. Identical reference symbols refer to identical or corresponding parts as in FIG. 1. In the embodiment shown in FIG. 2, the coupling 30 is configured in a different way. It comprises a snap-in device 32, which is attached to the support area 14. In the connected condition of the leash 34, the snap-in device 32 is overlapped by a sleeve element 36. The sleeve element 36 can be interlocked with the snap-in device 32 via a latching projection 40. By pressing a release button (not represented in the drawing) located on the sleeve element 36, the coupling is releasable by means of the latching projection 40, so that the leash 34 can be detached. In the embodiment represented here, a swivel joint 24 is located between the leash 34 and the sleeve element 36. Alternatively, it is possible to configure the latching projection 40 itself swiveling, so that the sleeve element 36 can swivel freely on the snap-in device 32. The swiveling joint 24 is then dispensable.

In the embodiment described here, the part of the leash 34 adjacent to the coupling 30 is slightly reinforced. The coupling 30 sustains or holds this part of the leash 34 upright, so that the leash 34 always extends upwardly and away. Consequently, the total length of the connection stub 18 is reduced significantly, e.g. to 2 cm.

In order to best keep it from getting dirty, the snap-in device 32 is preferably placed on the collar. Unquestionably, any other kind of coupling device is suitable for realizing the coupling according to the invention. If the embodiment is configured according to FIG. 2, the coupling 30 has to sustain that part of the leash 34 which is adjacent to the coupling 30 in the direction of the swivel axis 26. In the case of a connection stub 18 (cf. FIG. 1), sustaining in the direction of the swivel axis 26 is not necessary.

### SUMMARY

A control or guide means for animals, especially for dogs, comprising a collar or harness, which extends around the neck of the animal and is releasable, as well as comprising a device for fixing the position, whereby with said device a given turning position of the collar or harness relative to the animal can be fixed and further comprising a connecting means on the collar, characterized in that said connecting means has a connection stub (18), wherein said connection stub (18) stretches upwardly if said collar (12) or harness is put onto the animal, and wherein said connection stub (18) is attached to said collar (12) firmly and in such a way that it cannot kink, and wherein said connection stub (18) further has a coupling (30), especially a ring (28) or a snap-in device (32), located on the end of said connection stub (18) facing away from the animal.

1-11. (canceled)

12. A control or guide means for an animal, comprising:
a collar or harness (12) that is adapted to releasably extend about the neck of the animal;
a device for fixing a prescribed position of rotation of said collar or harness (12) relative to the animal; and
a connecting mechanism (16) disposed on said collar or harness (12), wherein said connecting mechanism is provided with a connection stub (18) that extends upwardly when said collar or harness is disposed about the neck of the animal, wherein said connection stub (18) is connected to said collar or harness (12) such that it cannot kink, and wherein on an end remote from said collar or harness, said connection stub (18) is provided with a coupling (30) that is adapted to receive a flexible and slack connecting element (34).

13. A control or guide means according to claim 12, wherein said coupling (30) is a ring (28) or a snap-in device (32).

14. A control or guide means according to claim 12, wherein said collar or harness (12) is provided with a support area (14) on a side remote from said connection stub (18), wherein said connection stub has a base that is fixedly connected with said collar or harness (12), and wherein said connection stub (18) extends essentially perpendicular to said support area (14).

15. A control or guide means according to claim 12, wherein said collar or harness (12) is provided with a support area (14), and wherein said support area is widened toward at least one of a forward and a rearward direction, relative to a head and a tail of the animal.

16. A control or guide means according to claim 15, wherein said support area (14) of said collar or harness (12) is widened to twice a width of said collar or harness.

17. A control or guide means according to claim 12, wherein said connection stub (18) is resiliently movable.

18. A control or guide means according to claim 17, wherein said connection stub (18) is comprised of a spiral spring (20) or of an elastomeric material.

19. A control or guide means according to claim 12, wherein said connection stub (18) has a length of from 1.5 to 30 cm.

20. A control or guide means according to claim 19, wherein said connection stub (18) has a length of from 5 to 20 cm.

21. A control or guide means according to claim 20, wherein said connection stub (18) has a length of approximately 12 to 15 cm.

22. A control or guide means according to claim 12, wherein said coupling (30) of said connection stub (18) has a free inside diameter of from 8 mm to 40 mm that is suitable for a connection to said flexible and slack connecting element (34).

23. A control or guide means according to claim 22, wherein said coupling (30) has a free inside diameter of approximately 20 mm.

24. A control or guide means according to claim 22, wherein said coupling (30) has a closed geometrical shape such as a ring or a torus.

25. A control or guide means according to claim 12, wherein said connection stub (18) tapers toward said coupling (30).

26. A control or guide means according to claim 25, wherein said coupling (30) is fixedly connected with said connection stub (18).

27. A control or guide means according to claim 12, wherein said coupling (30) is an upright ring.

28. A control or guide means according to claim 27, wherein said ring has a circular or semicircular shape.

29. A control or guide means according to claim 12, wherein said coupling (30) is provided with a swivel joint (24), and wherein an axis of rotation (26) of said swivel joint extends through said connection stub (18).

30. A control or guide means according to claim 12, wherein said coupling (30) is embodied as a snap-in device (32) that releasably cooperates with a further coupling (36) disposed on said flexible and slack connecting element (34), and wherein said snap-in device (32) holds a part of said connecting element (34) that is adjacent to said further coupling in alignment with said connection stub (18).

31. A control or guide means according to claim 30, wherein said part of said connecting element (34) that is adjacent to said further coupling (36) is reinforced or has a reduced flexibility.
